(19) United States
(12) Patent Application Publication
(10) Pub. No.: US 2014/0156028 A1
(43) Pub. Date: Jun. 5, 2014

(54) CLOUD-BASED BI-DIRECTIONAL MESSAGING SYSTEM FOR HOME APPLIANCE CONTROL

(71) Applicant: GENERAL ELECTRIC COMPANY, Schenctady, NY (US)

(72) Inventors: Balakrishna SUBRAMANIAM, Prospect, KY (US); Myles D. CALEY, La Grange, KY (US)

(73) Assignee: GENERAL ELECTRIC COMPANY, Schenctady, NY (US)

(21) Appl. No.: 13/690,360

(22) Filed: Nov. 30, 2012

(51) Int. Cl. G05B 19/02

(52) U.S. Cl. CPC G05B 19/02
USPC 700/11

(57) ABSTRACT

A system for home appliance control includes a plurality of home appliance controllers and a cloud-based service connected to these home appliance controllers through networking Each home appliance controller is configured to communicate with the cloud-based service via a bi-directional asynchronous messaging protocol regarding at least one home appliance. The cloud-based service includes a first interface and a second interface. The first interface is configured to receive a push request and send a push response related to at least one home appliance. The second interface is configured to communicate with the plurality of home appliance controllers.

### FIELD

The aspects of the disclosed embodiments generally related to home appliance control, and more particularly, to a cloud-based bi-directional messaging system for home appliance control.

### BACKGROUND

Home automation technologies are expanding rapidly encompassing communications, entertainment, security, convenience, and information systems. For example, occupants can remotely control or program home appliances through the home area network (HAN) in a smart home. A homeowner on her way back home can use a smart phone to send commands via her wireless carrier's network to the HAN to disarm a home security system, adjust a thermostat, switch lighting devices on, start a washer, and perform many other tasks. A HAN can enable not only communication among digital devices including home appliances typically deployed in the smart home, but also the sharing of Internet access, such as via fiber-to-the-home or via Cable Internet access, Digital Subscriber Line (DSL) or mobile broadband by Internet service providers (ISPs). A router is generally deployed in the HAN to allow networked devices in the HAN to share the Internet access. Moreover, a software or hardware based network firewall is typically coupled to the router to primarily secure the HAN from outside intrusions by controlling the incoming and outgoing network traffic based on a predetermined or heuristic rule set.

Utility companies are also interested in learning energy usage information of energy consuming devices in a home. Utility companies may facilitate and incentivize home energy management by consumers in an effort to collectively reduce energy usage during peak demand when utility companies have to buy extra energy to supply all consumers. Utility companies may use different rates as an incentive for consumers to reduce their energy usage during peak demand. Consequently consumers would appreciate a convenient way to reduce their energy usage during peak demand and subsequently reduce their energy bills. A mutually agreeable energy consumption schedule for home appliances would benefit both utility companies and consumers if such a schedule can systematically lower peak demand and aid in improving the efficiency, reliability, economics, and sustainability of the production and distribution of energy or other resources.

Consumers and utility companies can both resort to cloud computing for energy management as well as other functions with improved manageability and reduced maintenance. Cloud computing is the delivery of computing and storage capacity as a service to a heterogeneous community of end-recipients wherein the cloud providers manage the infrastructure and software; end-recipients simply lease these services.

Some existing communication models among cloud services, HANs, and users are essentially one-way synchronous models, such as Simple Object Access Protocol (SOAP) based communication protocol. Within such models, a request originated from one end is sent to the other end where the request is processed, and a response is created and sent back. The participants on either end are busy waiting for a response (in a blocked state) or processing the request. Such communication models limit efficient processing of messages. On the other side, devices behind a router and protected by a firewall are generously invisible to external managing entities associated with cloud services. Due to these limitations, it is difficult for utility companies to timely provide value-added services to a home appliance such as location feeds, pushed alerts, running on-demand queries to the devices, consumer alerts on the devices, etc.

Accordingly, it would be desirable to provide a cloud-based bi-directional messaging system for home appliance control that addresses at least some of the problems identified above.

### BRIEF DESCRIPTION OF THE DISCLOSED EMBODIMENTS

As described herein, the exemplary embodiments overcome one or more of the above or other disadvantages known in the art.

One aspect of the exemplary embodiments relates to a cloud-based bi-directional messaging system for home appliance control. In one embodiment, a system for home appliance control includes a plurality of home appliance controllers and a cloud-based service connected to these home appliance controllers through networking Each home appliance controller is configured to communicate with the cloud-based service via a bi-directional asynchronous messaging protocol regarding at least one home appliance. The cloud-based service includes a first interface and a second interface. The first interface is configured to receive a push request and send a push response related to at least one home appliance. The second interface is configured to communicate with the plurality of home appliance controllers. Moreover, the system may optionally include a messaging bridge that can translate messages in the system from one format to another.

Another aspect of the exemplary embodiments relates to a home appliance control device. The device has a processor which is configured to send a requesting message in a first format to a cloud-based service via a bi-directional asynchronous messaging protocol wherein the requesting message includes information related to at least one home appliance, receive a responding message in a second format from the cloud-based service via the bi-directional asynchronous messaging protocol, and execute a home appliance control process contained in the responding message.

Yet another aspect of the exemplary embodiments relates to a computer-implemented method of using bi-directional messaging for home appliance control. In one embodiment, the method includes sending a requesting message in a first format via a bi-directional asynchronous messaging protocol wherein the requesting message includes information related to at least one home appliance. The method also includes transforming the requesting message from the first format to a second format. The method further includes processing the requesting message. Moreover, the method includes generating a responding message in the second format wherein the responding message includes information related to the at least one home appliance. Furthermore, the method includes transforming the responding message from the second format to the first format. Finally the method includes receiving the responding message via the bi-directional asynchronous messaging protocol.

These and other aspects and advantages of the exemplary embodiments will become apparent from the following detailed description considered in conjunction with the accompanying drawings. It is to be understood, however, that the drawings are designed solely for purposes of illustration and not as a definition of the limits of the invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

The accompanying drawings illustrate presently preferred embodiments of the present disclosure, and together with the general description given above and the detailed description given below, serve to explain the principles of the present disclosure. As shown throughout the drawings, like reference numerals designate like or corresponding parts.

FIG. 1 is a block diagram generally representing a computer system into which aspects of the present disclosure may be incorporated;

FIG. 2 is a block diagram generally representing an exemplary architecture of system components for a cloud-based bi-directional messaging system for home appliance control incorporating aspects of the present disclosure;

FIG. 3 is a block diagram generally representing an exemplary architecture of system components for a messaging bridge incorporating aspects of the present disclosure;

FIG. 4 illustrates a flowchart of a process in an exemplary embodiment of a home appliance controller incorporating aspects of the present disclosure;

FIG. 5 illustrates a flowchart of a process in an exemplary embodiment of a cloud-based service incorporating aspects of the present disclosure; and

FIG. 6 illustrates a flowchart of another process in an exemplary embodiment of a cloud-based service incorporating aspects of the present disclosure.

### DETAILED DESCRIPTION OF THE EXEMPLARY EMBODIMENTS OF THE

DISCLOSURE

The present disclosure is generally directed towards a cloud-based bi-directional messaging system for home appliance control. As will be understood, the various diagrams, flow charts and scenarios described herein are only examples, and there are many other scenarios to which the present disclosure will apply.

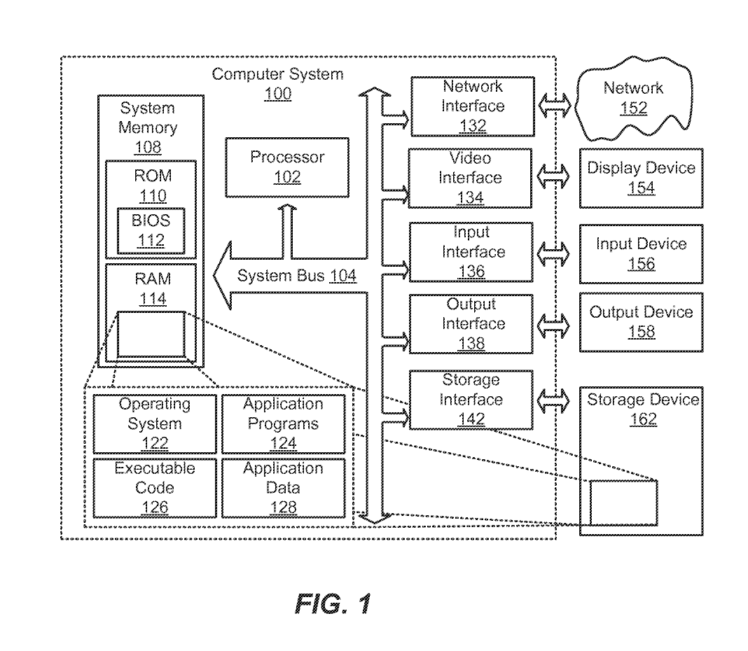

Turning to FIG. 1 of the drawings, there is shown a block diagram generally representing a computer system into which aspects of the present disclosure may be incorporated. Computing system 100 may be a personal computer (PC). In other examples the computing system may take the form of a special-purpose device, an appliance, a handheld computing device, a cellular telephone device, a pager device, etc.

As shown, computing system 100 includes processor 102 and system memory 108. These system components may communicate with each other via system bus 104. System bus 104 may be any of several types of bus structures including a memory bus or memory controller, a peripheral bus, and a local bus using any of a variety of bus architectures.

System memory 108 typically includes read only memory (ROM) 110 and random access memory (RAM) 114. ROM 110 generally contains a basic input/output system 112 (BIOS) which commonly provides basic routines needed during the start-up of computer system 100. ROM 110 is generally non-volatile while RAM 114 is often associated with volatile types of memory where its stored information is lost without power. Therefore, RAM 114 typically loads operating system 122, one or more application programs 124, executable code 126, and application data 128 from storage device 162, which is a type of non-volatile storage media, such as a hard drive.

Computing system 100 further includes video interface 134, input interface 136, output interface 138, storage interface 142, and network interface 132 wherein interfaces may facilitate computer system 100 to communicate with various external devices to perform various functions.

A display device 154, such as a monitor, may be connected to the system bus 104 via the video interface 134. Therefore, display device 154 may serve as an electronic visual display for computer system 100. It is noted that a touchscreen may use touching of the screen as an input method to select, unselect, move, activate, or deactivate objects displayed on the touchscreen. Thus, display device 154 may alternatively serve as an input device beyond its traditional function for visual display.

However, traditionally a user may enter commands and information into computing system 100 via various input device 156 such as a keyboard, a pointing device, electronic digitizer, a microphone, etc. Input device 156 is connected to the system bus 104 via the input interface 136.

In addition to display device 154, computing system 100 may generate output through other peripheral output devices 158, such as speakers, printers, etc. Output device 158 is connected to the system bus 104 via the output interface 138.

Storage device 162 may provide extended storage to computer system 100 via the storage interface 142. Storage device 162 may comprise one or more of a variety of computer-readable volatile or nonvolatile computer storage media, such as magnetic disk, compact disc (CD), digital versatile disks (DVD), Blu-ray disc (BD), magnetic cassette, magnetic tape, magnetic disk storage, or any other medium which can be used to store computer readable instructions, data structures, computer programs and other data.

Computing system 100 may operate in a networked environment via network interface 132. Computing system 100 may access one or more remote computers through network 152. Network 152 may include a local area network (LAN), a wide area network (WAN), a wireless network, or other types of network. In a networked environment, application programs and program data may be stored in and processed by a remote computer or a remote network. Thus the computer system 100 may be a centralized or a distributed system. Those skilled in the art will also appreciate that the computer system 100 may even be embedded within a system-on-a-chip architecture including memory, external interfaces and an operating system. It will be appreciated that the network connections shown are exemplary and other means of establishing a communications link between the computers may be used.

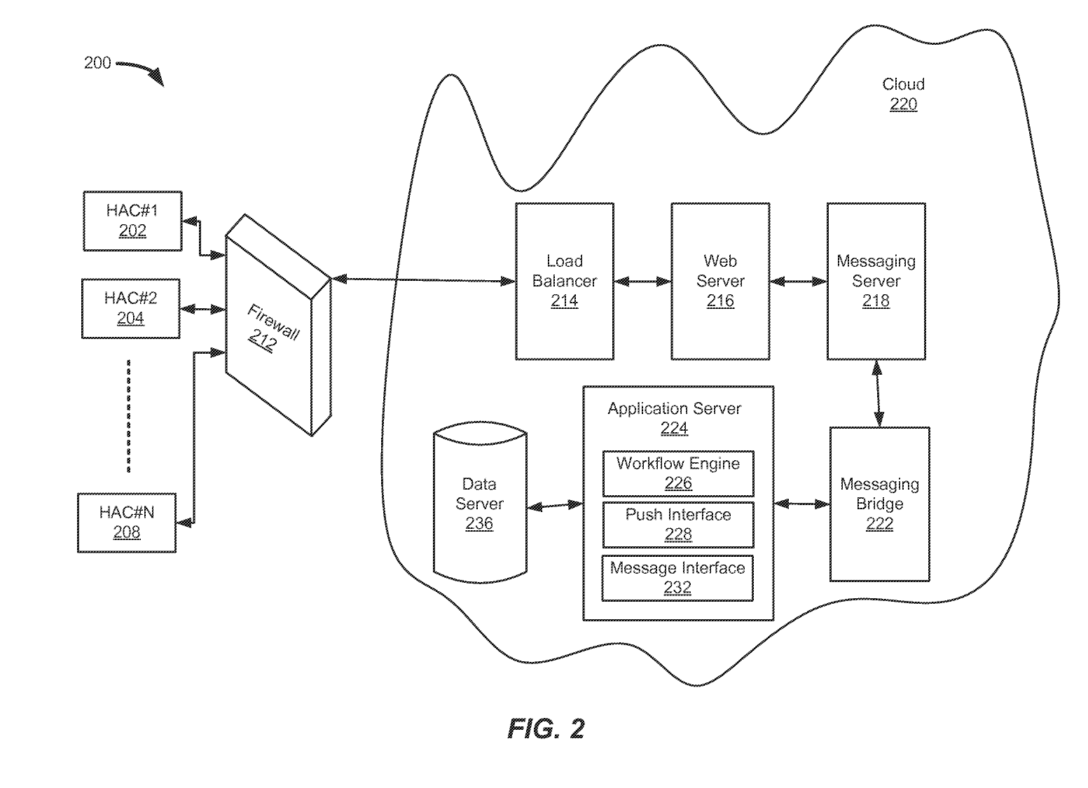

Now turning to FIG. 2, there is a block diagram generally representing an exemplary architecture of system components for a cloud-based bi-directional messaging system 200 for home appliance control incorporating aspects of the present disclosure. In various embodiments, a plurality of home appliance controllers (HAC) reside in the system 200, including HAC#1 202, HAC#2 204, and HAC#N 208. An HAC may be a device configured in a displayless housing with status indicators showing the status of the device, including computing capacities of storing, manipulating, and communicating information related to appliances under its management. Alternatively, an HAC may be a computer such as the computer system 100 in FIG. 1 or another variation of computing device including a mobile device.

These HACs are typically behind a firewall 212. A group of HACs may share a common firewall; alternatively each HAC may be coupled with its own firewall. In one embodiment, the software or hardware based firewall 212 may secure the HACs from outside intrusions by controlling the incoming and outgoing network traffic based on a predetermined or heuristic rule set. With a rule based firewall, each HAC may be associated with its own rule set although many HACs may share a common firewall. The firewall 212 generally divides a network into two parts, namely inside the firewall and outside the firewall. Network traffic inside the firewall 212 is presumed to be safe while network traffic outside the firewall 212 is presumed to be unsafe. As a result, networking entities outside the firewall 212 are generally not allowed to initiate communications with HACs. Consequently, HACs behind the firewall 212 are generally invisible from outside networking entities.

It is advantageous for HACs to communicate with outside networking entities in the Cloud 220 via a bi-directional messaging protocol with a light-weight protocol envelope for simple addressing. Therefore, the system 200 may improve HAC's visibility to outside networking entities and control HACs using push messages. Outside networking entities may initiate a transaction with a HAC by pushing a message to it. “Push” is contrasted with “pull” where the request for the transmission of information is initiated by a HAC. With push technology, outside networking entities may be equipped with group messaging capabilities which can be leveraged for utility management with software as a service (SaaS) model. Moreover, push technology will also enables value-added services such as location feeds, pushed alerts (DR), on-demand queries (DR), device control using mobile clients, etc.

The Extensible Messaging and Presence Protocol (XMPP) is an open technology for real-time communication, which powers a wide range of applications including instant messaging, presence, multi-party chat, voice and video calls, collaboration, lightweight middle-ware, content syndication, and generalized routing of XML data. Primarily due to its distributed nature, peer-to-peer bi-directional communication and presence paradigm, XMPP is one of the suitable protocols that can be used in the system 200.

Messages from HACs will first reach the load balancer 214 in the Cloud 220. The load balancer 214 may be a computer such as the computer system 100 in FIG. 1 or another variation of computing device. The load balancer 214 uses a computer networking methodology to selectively distribute incoming requests, commonly the Hypertext Transfer Protocol (HTTP) requests, across multiple computer servers to achieve optimal resource utilization, maximize throughput, minimize response time, and avoid overloading any one server. Moreover the load balancer 214 may ensure availability, increase reliability, and defend against denial of service (DOS) attacks with redundant servers.

Messages from HACs will be further selectively distributed to a server, such as the web server 216. The web server 216 may be a computer such as the computer system 100 in FIG. 1 or another variation of computing device. Traditionally a web server is used to deliver web pages upon a HTTP request from a web client. In the system 200, the web server 216 has the additional function of relaying messages from HACs to the messaging server 218. In various embodiments, the communication between a HAC and the web server 216 is firewall friendly. For example, in one embodiment, the bi-directional asynchronous messaging protocol used in the system 200 uses only a single outgoing connection from a HAC to outside networking entities over the Transmission Control Protocol (TCP). Therefore all incoming and outgoing messages can be routed over this single connection. In the case of XMPP, the administrator of the firewall 212 only needs to open port 5222 with TCP traffic to enable such bi-directional asynchronous messaging communication.

HTTP transport for HACs behind a very restricted firewall can also be configured if a desirable port would not be opened for such bi-directional asynchronous messaging communication in the system 200. Using a polling method, a HAC can use HTTP GET or POST requests to fetch or post messages stored on a server. Using a binding method, such as the Bidirectional-streams Over Synchronous HTTP (BOSH), messages can be pushed to a HAC using multiple synchronous HTTP request/response pairs (HTTP long polling) without requiring the use of frequent polling. Most firewalls would allow a HAC to fetch and post messages in HTTP without any hindrances. Thus, the load balancer 214 or the web server 216 may communicate with a HAC through standard HTTP ports over the firewall 212.

Moreover, a HAC can be configured to connect to only a single messaging server, such as the messaging server 218. The messaging server 218 may be a computer such as the computer system 100 in FIG. 1 or another variation of computing device. The messaging server 218 will relay all messages from the HAC to other servers. Furthermore, all messages can be encrypted during their transmission with various encryption mechanisms, such as Transport Layer Security (TLS) and its predecessor, Secure Sockets Layer (SSL).

The messaging server 218 provides at least basic messaging, presence, and routing functions. First, the messaging server 218 enables near-real-time instant messaging services to transmit text-based messages from sender to receiver within strict time constraints. Second, the messaging server 218 can store a HAC's presence or availability information and distribute to other interested watchers to convey the HAC's availability for communications. Third, the messaging server 218 can route a message from a HAC to a designated recipient or vice versa. In one embodiment, the messaging server 218 is implemented as an XMPP server to implement the XMPP protocol.

Not every networking entity in the Cloud 200 understands the bi-directional asynchronous messaging protocol used by HACs, particularly for those preexisting cloud services. The messaging bridge 222 may be used in this case to translate a message in its native format to another format which can be understood by those preexisting cloud services. The messaging bridge 222 may be a computer such as the computer system 100 in FIG. 1 or another variation of computing device. In one embodiment, the application server 224 uses the Java Message Service (JMS) API to communicate with its clients, and HACs use XMPP. Therefore, the messaging bridge 222 will transform messages back and forth between XMPP and JMS.

The application server 224 contains the workflow engine 226, the push interface 228, and the messaging interface 232. The application server 224 may be a computer such as the computer system 100 in FIG. 1 or another variation of computing device. The messaging interface 232 is configured to receive the message from a HAC via the messaging bridge 222 and send a responding message to the HAC. The push interface 228 may communicate with another cloud-based service or a user device (not depicted in FIG. 2) to receive a push request and send a push response back related to at least one home appliance managed by the HAC. The user device may include any computing or communication device, such as a wireless mobile communication device that is capable of communicating with the Cloud 220. Therefore, a consumer may configure and manager HACs through a user device such as a computer as described in FIG. 1, a smart phone, an iPad, a personal digital assistant (PDA), a smart television, or any type of computing or communication device.

The workflow engine 226 is configured to process all incoming messages from HACs via the message interface 232 or users via the push interface 228, particularly the payload from each message. Payload is the actual or body data in a message leaving out overhead data such as headers of various protocols for facilitating data transportation. In one embodiment, the payload from a message sent from a HAC contains Extensible Markup Language (XML) based data complying with web services frameworks such as Simple Object Access Protocol (SOAP) or Representational State Transfer (REST). Therefore a legacy system oriented to web services frameworks may easily adapt to the cloud-based bi-directional messaging system 200 by encapsulating messages designed for web services into the payload.

The workflow engine 226 is operably coupled with the data server 236 where historical data of HACs may be stored. Historical data of a HAC may include properties of each home appliance managed by the HAC, the energy consumption pattern, trend, and schedule of each home appliance, information of the program used to control each home appliance, etc. Moreover, the data server 236 may contain data regarding the energy supply and consumption information of a smart grid so that the workflow engine 226 may realize the actual peak demand or estimate demand based on such information stored in the data server 236. Furthermore, other types of data may be stored in the data server 236 or obtained directly from other cloud-based services so that the application server 224 may timely provide value-added services to a home appliance such as location feeds, pushed alerts, running on-demand queries to the devices, consumer alerts on the devices, etc.

The workflow engine 226 may generate a responding message to a HAC either of its own accord or after processing a message received from the push interface 228 or the message interface 232. The responding message may simply provide information requested by a requesting HAC, request information from another HAC, or contain a push request with commands to reduce, suspend, or stop energy use for one or more home appliances managed by yet another HAC. Moreover, the responding message may include a schedule of energy use for one or more home appliances managed by a HAC. Advantageously the schedule may incorporate the knowledge of both real-time information and historical information of a plurality of HACs, information of projected energy supply and consumption of the grid, and other ancillary information such as weather information. The schedule may be distributed to a HAC or a group of HACs to systematically lower peak demand and in furtherance of improving the efficiency, reliability, economics, and sustainability of the production and distribution of energy. Similarly, such a schedule may be configured to optimize usage of other resources such as water, gas, or networking bandwidth.

In general, a consumer can view, manage and control various aspects of the home energy usage in the system 200. In addition, the consumer can also view, manage and control all appliances that are connected to a HAC, only limited to the capabilities of each appliance. Meanwhile, utility companies can also implement energy management strategies with smart grid based dynamic response (DR) messaging due to the visibility of HACs outside of their respective firewalls in the system 200. Most importantly, the system 200 will allow effective two-way communications between a HAC and the Cloud 220 without any configuration changes on the consumer's home router and/or firewall.

Those skilled in the art will appreciate that the functions implemented within the blocks illustrated in the diagram may be implemented as separate components or the functions of several or all of the blocks may be implemented within a single component. For example, the load balancer 214 may be combined with the web server 216. As another example, the web server 216 or the messaging server 218 may be implemented outside of the Cloud 220. Yet as another example, the messaging bridge 222 may be incorporated into the application server 224 so that the application server 224 may directly communicate with the messaging server 218. Yet as another example, the push interface 228 may be combined with the message interface 232 to be a united messaging interface to handle all incoming and outgoing messages.

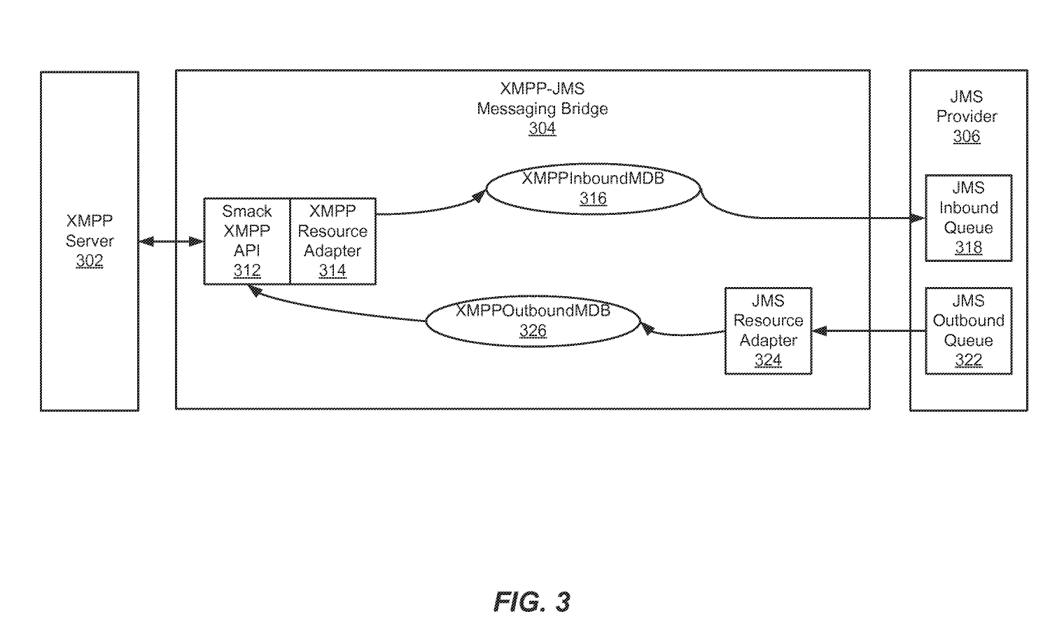

Now turning to FIG. 3, there is a block diagram generally representing an exemplary architecture of system components for a messaging bridge incorporating aspects of the present disclosure. In one embodiment, the messaging server 218 in FIG. 2 is implemented as an XMPP Server 302, and the message interface 232 in FIG. 2 is implemented as a JMS provider 306 which contains the JMS Inbound Queue 318 and the JMS Outbound Queue 322. Therefore, the messaging bridge 222 in FIG. 2 is implemented as the XMPP-JMS messaging bridge 304 that will transform messages back and forth between XMPP and JMS. The XMPP-JMS messaging bridge 304 contains the Smack XMPP API 312, XMPP Resource Adapter 314, XMPPInboundMDB 316, JMS Resource Adapter 324, and XMPPOutboundMDB 326.

The Smack XMPP API 312 is an open source XMPP client library for instant messaging and presence. It is embedded into the XMPP-JMS messaging bridge 304 to receive and send XMPP messages and create XMPP services such as presence-related services. The XMPP resource adapter 314 may be coupled to the Smack XMPP API 312 to enable connections between XMPP services and other applications. In the present embodiment, the XMPP resource adapter 314 complies with the Java Connector Architecture (JCA) specification and supports both inbound and outbound messaging.

After being processed by the Smack XMPP API 312 and the XMPP resource adapter 314, an XMPP message may enable XMPP based activation of an XMPPInboundMDB 316. The XMPPInboundMDB 316 is an enterprise bean that allows the JMS provider 306 to process messages asynchronously by acting as a JMS message listener. Once a message is captured by the XMPPInboundMDB 316, it will transform the message to become a JMS message and send it to the JMS Inbound Queue 318.

On the reverse direction, a responding message from the JMS outbound queue 322 may be first sent to the JMS resource adapter 324. The JMS resource adapter 324 enables connections between JMS services and other applications. The responding message may subsequently invoke a JMS based activation of an XMPPOutboundMDB 326. Once a message is captured by the XMPPOutboundMDB 326, it will transform the message to become a XMPP message and send the XMPP message to the Smack XMPP API 312. The Smack XMPP API 312 will finally return the responding message to the XMPP server 302.

In general, each of the XMPPInboundMDB 316 and the XMPPOutboundMDB 326 resembles a kind of stateless session bean wherein they retain no data or conversational state for a specific message, and they are just pooled to allow streams of messages to be processed concurrently.

With a messaging bridge such as the XMPP-JMS messaging bridge 304, participants in the system 200 may engage bi-directional asynchronous messaging communication. This will not only allow for more efficient use of computing cycles on either end and elimination of the blocked state while processing messages, but also enable for cross-protocol messaging.

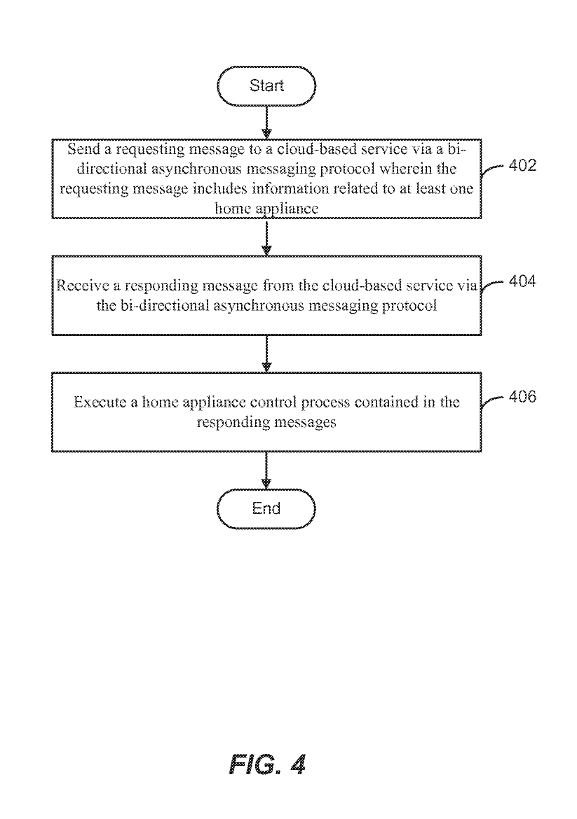

Now turning to FIG. 4, a flowchart illustrates and exemplary process in an embodiment of a home appliance controller incorporating aspects of the present disclosure. As indicated at process block 402, the process may include sending a requesting message to a cloud-based service via a bi-directional asynchronous messaging protocol wherein the requesting message includes information related to at least one home appliance. For example, the HAC#1 202 of FIG. 2 may send a requesting message in XMPP to the application server 224 with the current status of a dryer which indicates the dryer needs to run a full cycle with high heat.

As indicated at process block 404, the process may include receiving a responding message from the cloud-based service via the bi-directional asynchronous messaging protocol. For example, after the application server 224 processed the requesting message, it realized that running the dryer in the next two hours would incur a higher rate of energy charge for the consumer and also aggravate the dynamic peak demand in a smart grid. This knowledge may be derived from real time information from many HACs as well as the overall supply and demand information on the smart grid. Therefore the responding message may contain a new schedule for the dryer to shift its tasks to avoid the upcoming peak demand.

As further indicated at process block 406, the process may include executing a home appliance control process contained in the responding messages. For example, the HAC#1 202 may execute the new schedule received from the responding message and postpone the dry's task for at least two more hours after balancing the pros and cons of such action. With the cooperation of the HAC#1 202 and the cloud-based service in the system 200, resources may be distributed to households equitably and economically.

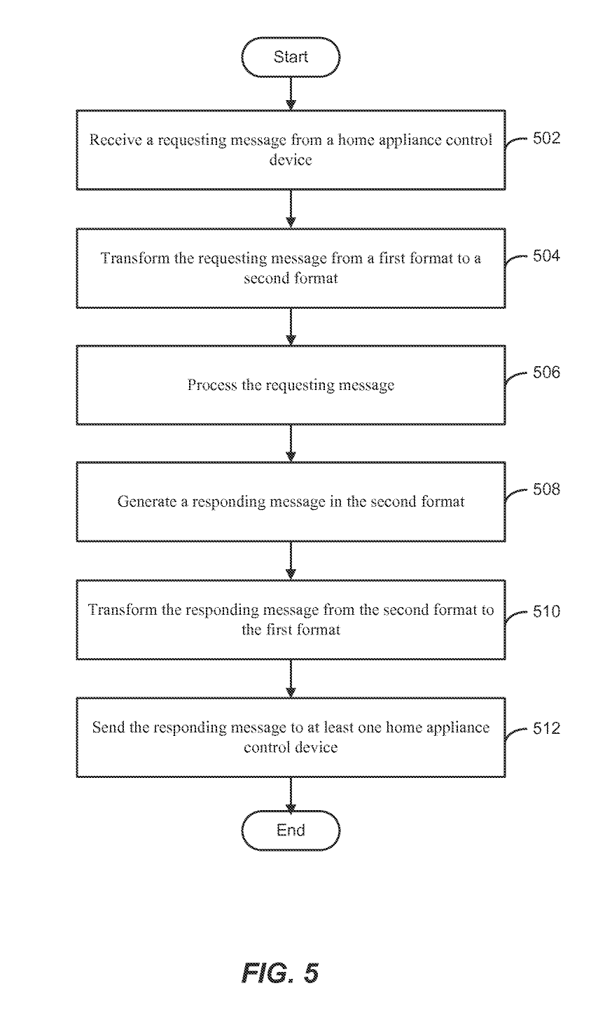

Now turning to FIG. 5, a flowchart illustrates an exemplary process in one embodiment of a cloud-based service incorporating aspects of the present disclosure. As indicated at process block 502, the process may include receiving a requesting message from a home appliance control device. For example, the messaging server 218 may receive a requesting message from the HAC#1 202 sent from the process block 402. As also indicated at process block 504, the process may include transforming the requesting message from a first format to a second format. For example, in the embodiment illustrated in FIG. 3, the first format is in XMPP, and the second format is in JMS. The XMPP-JMS messaging bridge 304 can transform the requesting message from XMPP to JMS.

As further indicated at process block 506, the process may include processing the requesting message. Processing a message can include extracting the payload from the messaging. Processing a message can also include understanding the semantics of the payload. Another aspect of processing a message includes gathering all relevant information. For example, upon receiving the message from the HAC#1 202 indicating that a dryer needs to run a cycle with high heat, the workflow engine 226 may consult with the data server 236 and other relevant cloud-based services to gather all relevant information, such as the status of other appliances located in the same household, the status of other HACs in the same region, the energy supply and consumption status on the grid, the weather condition, the energy consumption threshold imposed by either a consumer or a utility company, the push request from a consumer, etc.

As indicated at process block 508, the process may include generating a responding message in the second format after taking advantage of the comprehensive knowledge related to a HAC. The responding message may include information requested by the HAC or a recommended process to be executed by the HAC. Continuing with the aforementioned example, the workflow engine 226 may recommend a new schedule for the dryer to postpone the cycle with high heat for at least two hours due to an imminent projected peak demand in the region based on information collected from a plurality of nearby HACs.

As further indicated at process block 510, the process may include transforming the responding message from the second format to the first format. Moreover, the process may include sending the responding message to at least one home appliance control device at process block 512. For example, in the embodiment illustrated in FIG. 3, the XMPP-JMS messaging bridge 304 can transform the responding message from JMS to XMPP, and then the XMPP server 302 may send the responding message to its recipient. Advantageously, the responding message may be selectively distributed to a group of HACs based on group messaging technology if the workflow engine 226 determined the responding message would benefit the group of HACs to perform their respective functions.

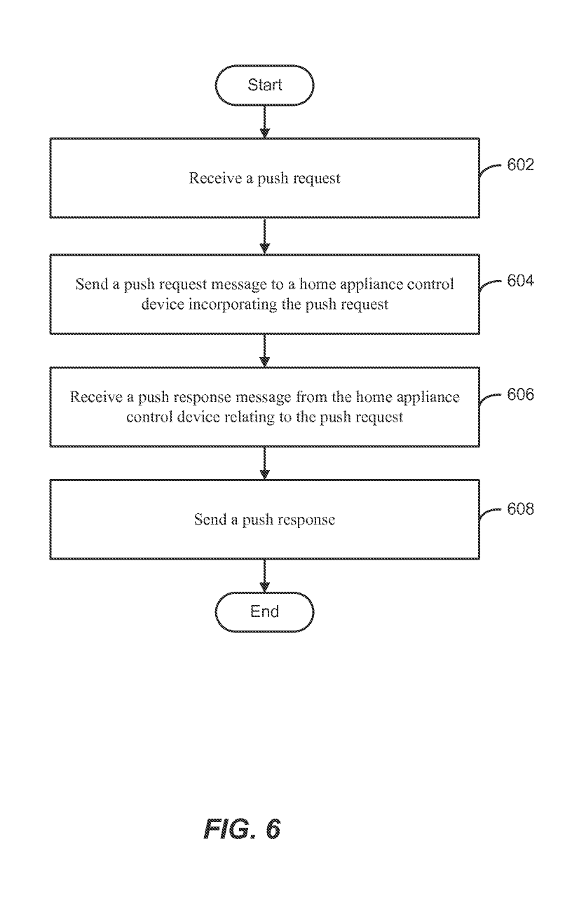

Now turning to FIG. 6, a flowchart illustrates another exemplary process in an embodiment of a cloud-based service incorporating aspects of the present disclosure. As indicated at process block 602, the process may include receiving a push request. The push request may be generated by a consumer, a utility company, or another cloud-based service. Such a push request may be used to retrieve information from or inquire the status of a HAC. Alternatively, such push request may contain executable commands to a HAC to manage and control various aspects of various appliances. For example, a consumer may send a push request to her dryer at home that orders the dryer to run a cycle when the energy rate is at the lowest level within next 12 hours.

As indicated at the process block 604, the process may include sending a push request message to a home appliance control device incorporating the aforementioned push request. Such push request message may alternatively be built into or combined with a responding message. Continuing with the aforementioned examples, the workflow engine 226 now may consider the push request as another constraint in recommending a new schedule for the dryer and generate a suitable schedule by synthesizing all information.

As indicated at the process block 606 and 608, the process may include receiving a push response message from the home appliance control device relating to the push request, and sending a push response back to where the push request was generated. For example, the dryer in former examples may finally confirm a new schedule to run the cycle at a particular time when the energy rate is the lowest and also bypassing the peak demand period.

The aspects of the disclosed embodiments allow a consumer to view, manage and control appliances that are connected to a home energy gateway using an extensible messaging and presence protocol. The home energy gateway can communicate with cloud services and enable messaging between the utility and the consumer in a time efficient manner, without the need for configuration changes on the consumer's home router.

Thus, while there have been shown, described and pointed out, fundamental novel features of the invention as applied to the exemplary embodiments thereof, it will be understood that various omissions and substitutions and changes in the form and details of devices and methods illustrated, and in their operation, may be made by those skilled in the art without departing from the spirit or scope of the invention. Moreover, it is expressly intended that all combinations of those elements and/or method steps, which perform substantially the same function in substantially the same way to achieve the same results, are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A system for home appliance control, comprising:
a home appliance controller configured to:
send a requesting message to a cloud-based service via a bi-directional asynchronous messaging protocol, wherein the requesting message comprises information related to at least one home appliance, and
receive a responding message from the cloud-based service via the bi-directional asynchronous messaging protocol,
wherein the cloud-based service is connected to the home appliance controller through networking including a first interface and a second interface,
wherein the first interface is configured to receive a push request and send a push response related to the at least one home appliance, and
wherein the second interface is configured to:
receive the requesting message, and
send the responding message to the home appliance control device.

2. The system of claim 1, wherein the home appliance controller is further configured to execute a home appliance control process contained in the responding message.

3. The system of claim 1, wherein the second interface is further configured to send the responding message to at least another home appliance controller.

4. The system of claim 1, wherein the responding message comprises information of the push request.

5. The system of claim 1, wherein the requesting message comprises information of the push response.

6. The system of claim 1, wherein the bi-directional asynchronous messaging protocol comprises XMPP.

7. The system of claim 1, wherein the requesting message is in a first format, and the responding message is in a second format.

8. The system of claim 7, wherein the first format is configured to comply with XMPP.

9. The system of claim 7, wherein the second format is configured to comply with JMS.

10. The system of claim 1, wherein the cloud-based service further comprises a messaging bridge wherein the messaging bridge transforms messages from the first format to the second format and vice-versa.

11. The system of claim 1, wherein the responding message comprises a schedule of energy use for the at least one home appliance.

12. The system of claim 11, wherein the schedule of energy use is based on real time information from a plurality of home appliance controllers.

13. The system of claim 11, wherein the schedule of energy use is based on historical information from a plurality of home appliance controllers.

14. The system of claim 11, wherein the schedule of energy use is based on information from an energy consumption projection on a smart grid.

15. A home appliance control device comprising:
a processor configured to:
send a requesting message in a first format to a cloud-based service via a bi-directional asynchronous messaging protocol, wherein the requesting message comprises information related to at least one home appliance,
receive a responding message in a second format from the cloud-based service via the bi-directional asynchronous messaging protocol, and
execute a home appliance control process contained in the responding message.

16. The device of claim 15, wherein the request message comprises a payload.

17. The device of claim 16, wherein the payload comprises data formatted for a web service.

18. The device of claim 15, wherein the bi-directional asynchronous messaging protocol comprises XMPP.

19. The device of claim 15, wherein the first format is configured to comply with XMPP.

19. The device of claim 15, wherein the second format is configured to comply with JMS.

20. The device of claim 15, wherein the home appliance control process comprises commands to reduce, suspend, or stop energy use for the at least one home appliance.

21. The device of claim 15, wherein the home appliance control process comprises a schedule of energy use for the at least one home appliance.

22. The device of claim 21, wherein the schedule of energy use is based on real time information from a plurality of home appliance control devices.

23. The device of claim 21, wherein the schedule of energy use is based on historical information from a plurality of home appliance control devices.

24. The device of claim 21, wherein the schedule of energy use is based on information from an energy consumption projection on a smart grid.

25. A method of using bi-directional messaging for home appliance control, comprising:
sending a requesting message in a first format via a bi-directional asynchronous messaging protocol, wherein the requesting message comprises information related to at least one home appliance;
transforming the requesting message from the first format to a second format;
processing the requesting message;
generating a responding message in the second format, wherein the responding message comprises information related to the at least one home appliance;
transforming the responding message from the second format to the first format; and
receiving the responding message via the bi-directional asynchronous messaging protocol.

26. The method of claim 25, wherein the bi-directional asynchronous messaging protocol comprises XMPP.

27. The method of claim 25, wherein the first format is configured to comply with XMPP.

28. The method of claim 25, wherein the second format is configured to comply with JMS.

29. The method of claim 25, wherein the responding message comprises a schedule of energy use for the at least one home appliance.

30. The method of claim 25, wherein the schedule of energy use is based on real time information from a plurality of home appliance control devices.

31. The method of claim 25, wherein the schedule of energy use is based on historical information from a plurality of home appliance control devices.

32. The method of claim 25, wherein the schedule of energy use is based on information from an energy consumption projection on a smart grid.
